(19) United States
(12) Patent Application Publication
(10) Pub. No.: US 2001/0022340 A1
(43) Pub. Date: Sep. 20, 2001

(54) Electro-optic probe

(76) Inventors: Akishige Ito, Tokyo (JP); Katsushi Ohta, Tokyo (JP); Mitsuru Shinagawa, Isehara-shi (JP); Tadao Nagatsuma, Sagamihara-shi (JP); Hakaru Kyuragi, Tokyo (JP); Kazuhide Ohno, Zama-shi (JP); Jin Yoshito, Atsugi-shi (JP)

Correspondence Address: Robert E. Krebs, Esq., BURNS, DOANE, SWECKER & MATHIS, L.L.P., P.O. Box 1404, Alexandria, VA, 22313-1404, US

(21) Appl. No.: 09/738,765

(22) Filed: Dec. 18, 2000

(30) Foreign Application Priority Data
Dec. 28, 1999 (JP) 11-377342

(51) Int. Cl. H01J 40/14

(52) U.S. Cl. 250/214 R

(57) ABSTRACT

Disclosed is an electro-optic probe which comprises a laser diode for emitting a laser beam based on a control signal from a main body of a measuring unit; an electro-optic element having a reflection film on an end face; first isolators, provided between the laser diode and the electro-optic element, for passing the laser beam emitted from the laser diode and separating reflected light of the laser beam reflected by the reflection film; two photodiodes for converting the reflected light separated by the first isolator into electric signals; and a second isolator provided on an optical path which connects the photodiodes to the first isolator.

### BACKGROUND OF THE INVENTION

1. Field of the Invention

The present invention relates to an electro-optic probe which couples an electric field generated by a to-be-probed signal to an electro-optic crystal, allows light to enter the electro-optic crystal and observes the waveform of the to-be-probed signal in accordance with the polarization state of the incident light, and, more particularly, to an electro-optic probe with an improved optical system.

This application is based on Japanese Patent Application No. Hei 11-377342 filed in Japan, the content of which is incorporated herein by reference.

2. Description of the Related Art

As an electric field, generated by a to-be-probed signal, is coupled to an electro-optic crystal and a laser beam is allowed to enter the electro-optic crystal, the waveform of the to-be-probed signal can be observed in accordance with the polarization state of the incident light. If a pulse-like laser beam is allowed to used and a to-be-probed signal is sampled, the waveform of the to-be-probed signal can be measured with a very high time resolution. An electro-optic sampling (EOS) oscilloscope uses an electro-optic probe which utilizes this phenomenon.

The EOS oscilloscope has the following advantages over a conventional sampling oscilloscope using an electric probe and has therefore drawn attention.

1) Since no ground line is needed at the time of measuring a signal, measurement is easier.

2) As the metal pin at the distal end of the electro-optic probe is electrically insulated from the circuit system, a high input impedance can be realized, so that the status of a point to be probed is mostly undisturbed.

3) The use of an optical pulse ensures wide-band measurement in the GHz order.

The structure of a conventional electro-optic probe (hereinafter called “probe”) which is used at the time of measuring a signal with an EOS oscilloscope will be described with reference to FIG. 2. In FIG. 2, numeral “1” denotes a probe head made of an insulator in the center of which a metal pin 1a is fitted. Numeral “2” denotes an electro-optic element which has a reflection film 2a provided on the metal-pin side end face. The reflection film 2a is in contact with the metal pin 1a. Numerals “3” and “8” are collimator lenses. Numeral “4” denotes a ¼ wavelength plate. Numerals “5” and “7” are polarization beam splitters. Numeral “6” denotes a Faraday cell which turns the polarization plane of incident light by 45 degrees. Numeral “9” denotes a laser diode which emits a laser beam in accordance with a control signal output from a pulse generator (not shown) of an EOS oscilloscope body 19. Numerals “10” and “11” denote collimator lenses. Numerals “12” and “13” denote photodiodes which convert input laser beams to electric signals and send the electric signals to the EOS oscilloscope body 19. Numeral “14” is an isolator which comprises the ¼ wavelength plate 4, the polarization beam splitters 5 and 7 and the Faraday cell 6. Numeral “15” is a probe body made of an insulator.

The optical path of a laser beam emitted from the laser diode 9 will be discussed below with reference to FIG. 2 in which the optical path of the laser beam is represented by symbol “A”.

The laser beam that has been emitted from the laser diode 9 is converted by the collimator lens 8 to parallel light which travels straight through the polarization beam splitter 7, the Faraday cell 6 and the polarization beam splitter 5, and further passes through the ¼ wavelength plate 4. The light is condensed by the collimator lens 3 and then enters the electro-optic element 2. The incident light is reflected by the reflection film 2a formed at the metal-pin side end face of the electro-optic element 2.

The reflected laser beam is converted again to parallel light by the collimator lens 3. The parallel light passes through the ¼ wavelength plate 4. A part of this laser beam is reflected by the polarization beam splitter 5, and then enters the photodiode 12. The laser beam that has passed the polarization beam splitter 5 is reflected by the polarization beam splitter 7 and then enters the photodiode 13.

The ¼ wavelength plate 4 adjusts the intensities of the laser beams to enter the photodiodes 12 and 13 in such a way that the light intensities become identical.

The operation of measuring a to-be-probed signal using the electro-optic probe shown in FIG. 2 will now be discussed. As the metal pin 1A comes in contact with a point to be probed, an electric field generated by the voltage that is applied to the metal pin 1A propagates to the electro-optic element 2, so that the index of refraction of the electro-optic element 2 changes due to the Pockels effect. As the laser beam emitted from the photodiode 9 enters the electro-optic element 2 and propagates in the electro-optic element 2, the polarization state of the light changes. The laser beam whose polarization state has been changed is reflected by the reflection film 2a and enters the photodiodes 12 and 13 to be converted to electric signals.

The change in the polarization state that occurs in the electro-optic element 2 in accordance with a change in the voltage at the to-be-probed point appears as the difference between the outputs of the photodiodes 12 and 13. The electric signal that is applied to the metal pin 1a can be measured by detecting this output difference.

The electro-optic probe of the prior art may suffer such a phenomenon that light incident to the photodiodes 12 and 13 is reflected by the windows or the like of light-incident holes formed in the photodiodes 12 and 13 and return toward the light source. The returned light eventually become noise light, thus causing the S/N ratio of the to-be-probed signal to deteriorate. There may occur another phenomenon such that the light emitted from the laser diode 9 is reflected at the surface or the like of an optical component provided in the probe, returns to the laser diode 9 and is reflected by the window of the light-emerging hole of the laser diode 9. This light also eventually becomes noise light, thus causing the S/N ratio of the to-be-probed signal to deteriorate.

### SUMMARY OF THE INVENTION

Accordingly, it is an object of the present invention to provide an electro-optic probe that reduces noise light generated inside the probe to thereby ensure an improvement in the S/N ratio of the to-be-probed signal.

According to one aspect of this invention, the above object is achieved by an electro-optic probe which comprises a laser diode (9) for emitting a laser beam based on a control signal from a main body of a measuring unit; an electro-optic element (2) having a reflection film (2a) on an end face; first isolators (4, 5, 6, 7), provided between the laser diode (9) and the electro-optic element (2), for passing the laser beam emitted from the laser diode (9) and separating reflected light of the laser beam reflected by the reflection film (2a); two photodiodes for converting the reflected light separated by the first isolators (4, 5, 6, 7) into electric signals; and a second isolator (21) provided on an optical path which connects the photodiodes to the first isolators (4, 5, 6, 7).

According to another aspect of the invention, the above object is achieved by an electro-optic probe which comprises a laser diode (9) for emitting a laser beam based on a control signal from a main body of a measuring unit; an electro-optic element (2) having a reflection film (2a) on an end face; first isolators (4, 5, 6, 7), provided between the laser diode (9) and the electro-optic element (2), for passing the laser beam emitted from the laser diode (9) and separating reflected light of the laser beam reflected by the reflection film (2a); two photodiodes for converting the reflected light separated by the first isolators into electric signals; and a second isolator (20) provided on an optical path which connects the laser diode (9) to the first isolators (4, 5, 6, 7).

As noise light, which is generated inside the probe, is blocked by the isolator, this invention provides such an advantage as to be able to improve the S/N ratio of the to-be-probed signal. Further, as the isolator in use is of a polarization-independent type which does not depend on the polarization state of incident light, all noise light can be blocked regardless of the polarization state of the light.

### BRIEF DESCRIPTION OF THE DRAWINGS

FIG. 1 is a structural diagram showing the structure of one embodiment of the present invention; and

FIG. 2 is a structural diagram illustrating the structure of an electro-optic probe according to the prior art.

### DETAILED DESCRIPTION OF THE PREFERRED EMBODIMENT

The embodiment which will be discussed below does not limit the present invention as recited in the appended claims. All the features that will be described in the following description of the embodiment need not necessarily be combined in order to achieve the aforementioned object.

An electro-optic probe according to one embodiment of this invention will now be described with reference to the accompanying drawings.

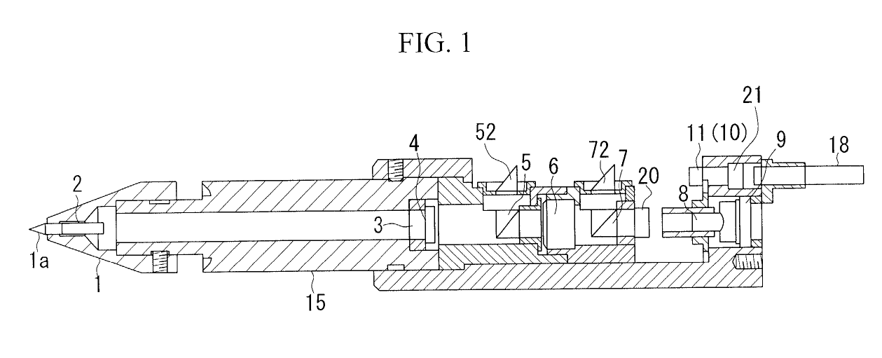

FIG. 1 shows the structure of the embodiment. In FIG. 1, numeral “1” denotes a probe head made of an insulator in the center of which a metal pin 1a is fitted. Numeral “2” denotes an electro-optic element which has a reflection film 2a provided on the metal-pin side end face. The reflection film 2a is in contact with the metal pin 1a. Numerals “3” and “8” denote collimator lenses. Numeral “4” denotes a ¼ wavelength plate. Numerals “5” and “7” denote polarization beam splitters. Numeral “6” denotes a Faraday cell which turns the polarization plane of incident light by 45 degrees. Numeral “9” denotes a laser diode which emits a laser beam in accordance with a control signal output from a pulse generator (not shown) of an EOS oscilloscope body 19. Numerals “10” and “11” are collimator lenses. The first isolator that is recited in the appended claims is comprised of the ¼ wavelength plate 4, the polarization beam splitters 5 and 7 and the Faraday cell 6. Numeral “15” is a probe body made of an insulator.

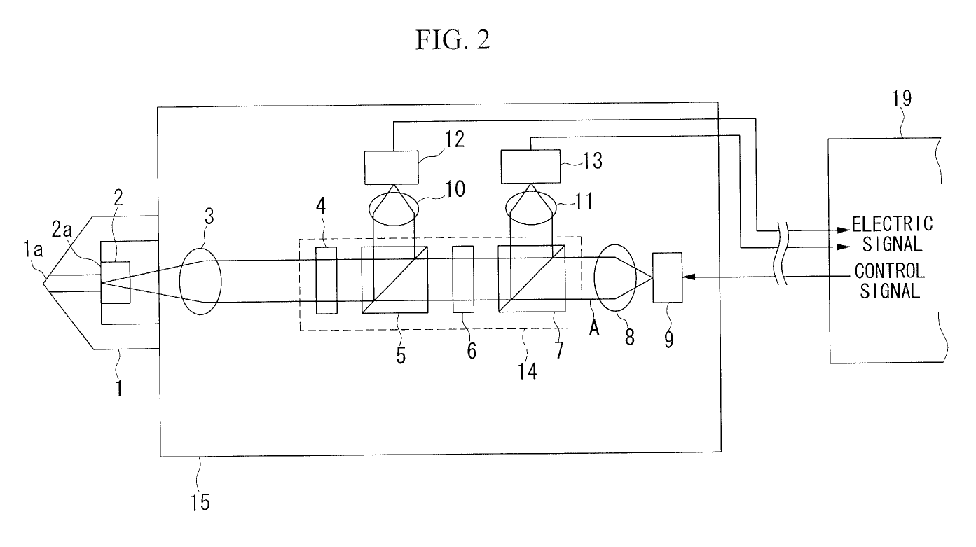

The probe shown in FIG. 1 differs from the prior art shown in FIG. 2 in that prisms 52 and 72 are provided and the collimator lenses 10 and 11 are arranged in such a way as to make the optical axes of the laser beams incident on the collimator lenses 10 and 11 parallel to the optical axis of the laser beam emitted from the laser diode 9, and that photodiodes 12 and 13 (not shown in FIG. 1) are provided in the EOS oscilloscope body and the probe body 15 is connected to the photodiodes by optical fibers 18. Further, an isolator 20 is provided in the optical path that connects the laser diode 9 to the polarization beam splitter 7. An isolator 21 is provided in the optical path that connects the collimator lens 10 to the light-incident port of the associated optical fiber 18. Another isolator 21 is also provided for the condenser lens 11.

The isolators 20 and 21 provided in the probe are optical isolators which pass light traveling in one direction but block light traveling in the other direction. The isolators 20 and 21 are of a polarization-independent type which does not depend on the polarization state of incident light. The isolator 20 is arranged so as to pass light traveling toward the polarization beam splitter 7 from the laser diode 9 and to block light traveling in the other direction. The isolators 21 are arranged so as to pass light traveling toward the optical fibers 18 from the collimator lenses 10 and 11 and block light traveling in the other direction.

Because the other structures and operations are the same as those of the prior art, their detailed descriptions will be omitted and the optical path of the light in the probe will be discussed below.

The optical path of the laser beam emitted from the laser diode 9 will be discussed below with reference to FIG. 1. The laser beam that has been emitted from the laser diode 9 is converted by the collimator lens 8 to parallel light which passes through the isolator 20. As the isolator 20 blocks the light that returns toward the laser diode 9, noise light can be reduced. The light then travels straight through the polarization beam splitter 7, the Faraday cell 6 and the polarization beam splitter 5, and further passes through the ¼ wavelength plate 4. The light is condensed by the collimator lens 3 and then enters the electro-optic element 2. The incident light is reflected by the reflection film 2a formed at the metal-pin side end face of the electro-optic element 2.

The reflected laser beam is converted again to parallel light by the collimator lens 3. The parallel light passes through the ¼ wavelength plate 4. A part of this laser beam is reflected by the polarization beam splitter 5, and is then turned back by the prism 52. The resultant light is condensed by the collimator lens 10 and then passes the isolator 21. As the isolator 21 blocks the light that returns toward the collimator lens 10, noise light can be reduced. The light that has passed the isolator 21 enters through the light-incident port of the associated optical fiber 18 and travels in the optical fiber 18 to enter the associated photodiode. The laser beam that has passed the polarization beam splitter 5 is reflected by the polarization beam splitter 7, and is turned back by the prism 72. The resultant light is condensed by the collimator lens 11 and then passes the isolator 21. Likewise, the isolator 21 can block the light that returns toward the collimator lens 11. The light that has passed the isolator 21 enters through the light-incident port of the associated optical fiber 18 and travels in the optical fiber 18 to enter the associated photodiode.

Although the electric signal that is acquired from each photodiode is the above-described electro-optic probe is input to the EOS oscilloscope and processed there, an existing measuring unit, such as a real-time oscilloscope, may be connected to the photodiodes via a special controller to measure the to-be-probed signal. This modification can ensure easy wide-band measurement using the electro-optic probe.

The provision of the isolator 20 that blocks the light returning toward the laser diode 9 and the isolators 21 that blocks the return light from the photodiodes can reduce noise light that is generated in the probe.

What is claimed is:

1. An electro-optic probe comprising:
a laser diode for emitting a laser beam based on a control signal from a main body of a measuring unit;
an electro-optic element having a reflection film on an end face;
first isolators, provided between said laser diode and said electro-optic element, for passing said laser beam emitted from said laser diode and separating reflected light of said laser beam reflected by said reflection film;
two photodiodes for converting said reflected light separated by said first isolators into electric signals; and
a second isolator provided on an optical path which connects said photodiodes to said first isolators.

2. The electro-optic probe according to claim 1, wherein said second isolator passes light traveling toward said photodiodes from said first isolators and blocks light traveling toward said first isolators from said photodiodes.

3. The electro-optic probe according to claim 2, wherein said second isolator is a polarization-independent type which does not depend on a polarization state of incident light entering said second isolator.

4. An electro-optic probe comprising:
a laser diode for emitting a laser beam based on a control signal from a main body of a measuring unit;
an electro-optic element having a reflection film on an end face;
first isolators, provided between said laser diode and said electro-optic element, for passing said laser beam emitted from said laser diode and separating reflected light of said laser beam reflected by said reflection film;
two photodiodes for converting said reflected light separated by said first isolators into electric signals; and
a second isolator provided on an optical path which connects said laser diode to said first isolator.

5. The electro-optic probe according to claim 4, wherein said second isolator passes light emitted from said laser diode and traveling toward said first isolators and blocks light traveling toward said laser diode from said first isolators.

6. The electro-optic probe according to claim 5, wherein said second isolator is a polarization-independent type which does not depend on a polarization state of incident light entering said second isolator.
